(19) United States
(12) Patent Application Publication
(10) Pub. No.: US 2025/0314997 A1
(43) Pub. Date: Oct. 9, 2025

(54) IMAGE FORMING APPARATUS FOR FORMING TONER IMAGE FOR ADHERING FOIL ONTO SHEET

(71) Applicant: CANON KABUSHIKI KAISHA, Tokyo (JP)

(72) Inventors: Kota Kurokawa, Chiba (JP); Tohru Nakaegawa, Chiba (JP); Shingo Hirota, Ibaraki (JP); Shuichi Tamura, Ibaraki (JP); Kenichiro Kitajima, Ibaraki (JP); Ryohei Terada, Chiba (JP); Daisuke Katayama, Chiba (JP); Shuhei Yasuda, Chiba (JP)

(21) Appl. No.: 19/093,537

(22) Filed: Mar. 28, 2025

(30) Foreign Application Priority Data
Apr. 3, 2024 (JP) 2024-060396

(51) Int. Cl. G03G 15/00

(52) U.S. Cl. CPC G03G 15/55; G03G 15/5016; G03G 15/5029; G03G 15/5095; G03G 15/6582

(57) ABSTRACT

An image forming unit forms a toner image on a sheet. An input unit accepts a selection of a first mode for forming the toner image for adhering foil onto the sheet via the toner image, and an input of information related to a margin area set to be an area where the toner image is not formed by the image forming unit on the sheet. A display unit displays a warning according to the information related to the margin area in a case where the first mode is selected by the input unit.

### BACKGROUND OF THE INVENTION

### Field of the Invention

The present invention relates to an image forming apparatus for forming a toner image for adhering foil onto a sheet.

### Description of the Related Art

Foil printing technology is used in the fields of bookbinding, commercial printing, card business, and plastic molding for cosmetic containers, among others. Text or designs made of foil can achieve a metallic feel that is difficult to express with printing and provide a glossy finish. Foil printing is also used for holograms of credit cards and the like. According to Japanese Patent Laid-Open No. 2017-156723 and Japanese Patent Laid-Open No. 2021-116185, there has been proposed a foil printer in which a toner image is formed on a sheet in advance, and foil is transferred onto the sheet by using the toner image as an adhesive.

However, when the foil is adhered to the sheet via the toner, there is a possibility that a defect will occur when the foil is formed depending on the toner image to be formed.

### SUMMARY OF THE INVENTION

The present disclosure provides an image forming apparatus comprising: an image forming unit configured to form a toner image on a sheet; an input unit configured to accept a selection of a first mode for forming the toner image for adhering foil onto the sheet via the toner image, and an input of information related to a margin area set to be an area where the toner image is not formed by the image forming unit on the sheet; and a display unit configured to display a warning according to the information related to the margin area in a case where the first mode is selected by the input unit.

Further features of the present invention will become apparent from the following description of exemplary embodiments with reference to the attached drawings.

### BRIEF DESCRIPTION OF THE DRAWINGS

FIG. 1 is a diagram illustrating an image forming system.

FIGS. 2A and 2B are diagrams illustrating foil processing.

FIGS. 3A and 3B are diagrams illustrating a user interface.

FIG. 4 is a diagram illustrating a user interface.

FIG. 5 is a diagram illustrating a user interface.

FIG. 6 is a diagram illustrating a controller.

FIG. 7 is a flowchart showing a control method.

FIGS. 8A and 8B are diagrams illustrating a toner image and a margin.

FIGS. 9A and 9B are diagrams illustrating a user interface.

FIGS. 10A and 10B are diagrams illustrating a user interface.

FIG. 11 is a diagram illustrating a user interface.

FIG. 12 is a diagram illustrating a user interface.

FIG. 13 is a flowchart showing a control method.

FIG. 14 is a diagram illustrating a user interface.

FIG. 15 is a flowchart showing a control method.

FIG. 16 is a diagram illustrating a user interface.

FIG. 17 is a diagram illustrating a user interface.

FIG. 18 is a flowchart showing a control method.

FIG. 19 is a diagram illustrating a user interface.

FIG. 20 is a flowchart showing a control method.

FIG. 21 is a diagram illustrating an image forming system.

FIG. 22 is a diagram illustrating an image forming system.

FIG. 23 is a diagram illustrating a controller. FIG. 24 is a flowchart showing a control method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### I. First embodiment

### 1. Image Forming System (Foil Printing System)

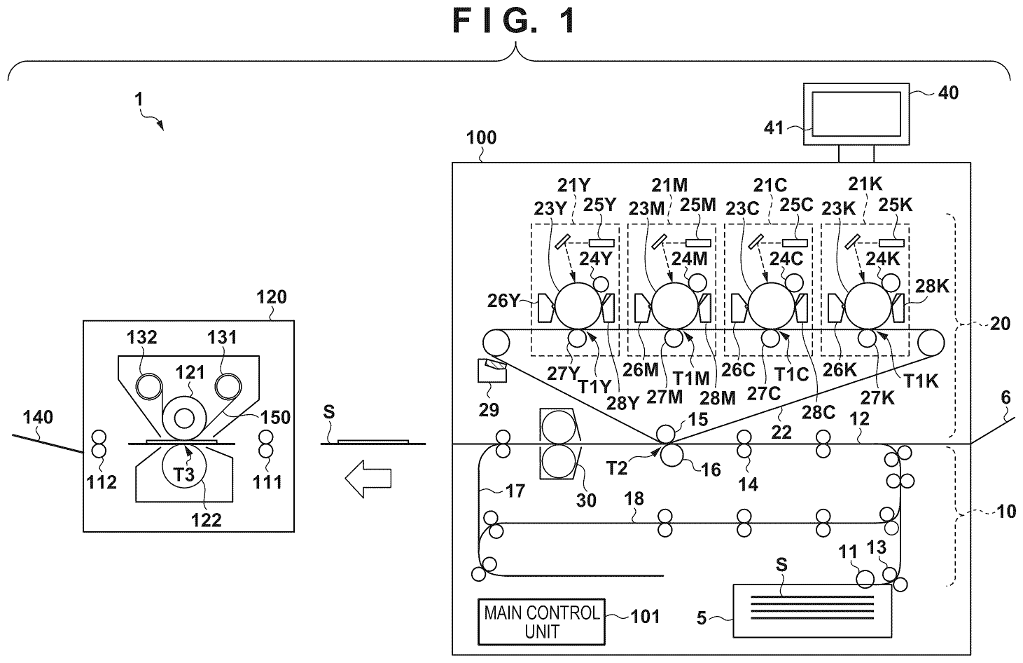

As shown in FIG. 1, an image forming system 1 includes an image forming apparatus 100 and a foil printer 120. The image forming apparatus 100 forms a toner image on a sheet (also referred to as a recording material) S. The foil printer 120 prints foil onto the sheet S using a toner of the toner image as a glue.

The image forming system 1 is a so-called offline type system in which the foil printer 120 is not mechanically coupled to image forming apparatus 100.

In this case, the sheet S on which the toner image is formed is discharged from image forming apparatus 100 and then manually inserted into the foil printer 120 by a user (see an arrow in the drawing). In other embodiments, an inline type system may be provided in which the foil printer 120 is coupled to image forming apparatus 100. In this case, the sheet S is automatically transferred from image forming apparatus 100 to the foil printer 120. In yet another embodiment, an integrated printing device may be provided that incorporates the foil printing capability of the foil printer 120 into the interior of the image forming apparatus 100.

### 1-1. Image Forming Apparatus

The image forming apparatus 100 may be a color printer or a monochrome printer. In the example of FIG. 1, the image forming apparatus 100 is a tandem full color printer capable of forming full color images with an electrophotographic manner. The image forming apparatus 100 includes a cassette 5, a manual feed tray 6, a conveyance unit 10, an image forming unit 20, a fixing unit 30, an operation unit 40, and a main control unit 101.

The image forming unit 20 is an image forming unit including a process unit 21Y, 21M, 21C and a 21K, an intermediate transfer belt 22, and a belt cleaner 29. The process units 21Y, 21M, 21C and 21K are arranged in parallel along the moving direction of the intermediate transfer belt 22 to form toner images of yellow, magenta, cyan, and black, respectively. Note that Y, M, C, and K characters assigned to the end of the reference numerals in FIG. 1 may be omitted when the matters common to the four colors are described. The intermediate transfer belt 22 is stretched over a plurality of rollers and rotates. As will be described later, the toner images of the four color components are transferred to the intermediate transfer belt 22 and superimposed on each other (primary transfer), thereby forming a full-color toner image. The intermediate transfer belt 22 carries the full-color toner image and conveys it to a secondary transfer position T2.

The cassette 5 is an accommodation unit that accommodates a bundle of sheets. Although FIG. 1 shows an embodiment in which the image forming apparatus 100 includes only one cassette 5, the image forming apparatus 100 may include a plurality of cassettes 5 capable of accommodating sheets S of differing types (e.g., size, thickness, or presence or absence of surface-coating). In this case, the sheet S of the type designated in each job is fed from the corresponding cassette 5. Note that the sheet S may be fed from a manual feed tray 6 instead of the cassette 5. Further, the image forming system 1 may include a paper feeder (not illustrated) separate from image forming apparatus 100.

The conveyance unit 10 is a conveyance unit including a conveyance path and a plurality of rollers. The feeding roller 11 feeds the sheets one by one from the bundle of the sheets S in the cassette 5 to the conveyance path 12. The conveyance roller 13 conveys the sheet along the conveyance path 12. The registration roller 14 feeds the sheet S to the secondary transfer position T2 in synchronization with the timing at which the toner image on the intermediate transfer belt 22 reaches the secondary transfer position T2.

Since the configuration of the process unit 21Y, 21M, 21C and 21K may be similar to each other, they are referred to as a process unit 21. The process unit 21 includes a photosensitive drum 23, a charger 24, an exposure unit 25, a developing unit 26, a primary transfer roller 27, and a drum cleaner 28. The photosensitive drum 23 is a cylindrical image carrier and rotates in the counterclockwise direction in the drawing. The charger 24 may be, for example, a corona charger that irradiates charged particles by corona discharge, and charges the surface of the photosensitive drum 23 to a uniform potential (e.g. a negative dark portion potential). The charger 24 may have a roller or a wire for discharging. The exposure unit 25 includes, for example, a semiconductor laser as a light source, and scans the surface of the photosensitive drum 23 with a laser beam according to the input image data to form an electrostatic latent image on the surface of the photosensitive drum 23. The developing unit 26 accommodates, for example, a developer including a toner and a carrier in its interior, and develops the electrostatic latent image on the surface of the photosensitive drum 23 by supplying the developer to the photosensitive drum 23 to form a toner image.

As an example, the developer may be a two-component developer including a non-magnetic toner and a magnetic carrier. The toner may contain a binder resin, a colorant, and a release agent (wax).

A primary transfer roller 27 is disposed at a primary transfer position T1 so as to face the photosensitive drum 23. The primary transfer roller 27 is supplied with a primary transfer bias of high voltage and transfers the toner image (here, yellow) on the surface of the photosensitive drum 23 to the intermediate transfer belt 22. The drum cleaner 28 removes a toner remaining on the surface of the photosensitive drum 23 after the primary transfer.

Similar to the process unit 21Y, magenta, cyan, and black toner images are formed in the process units 21M, 21C and 21K, respectively. Then, these toner images are sequentially transferred and superimposed on the yellow toner image on the intermediate transfer belt 22.

A secondary transfer outer roller 16 is disposed at the secondary transfer position T2 so as to face a secondary transfer inner roller 15, which is one of the rollers over which the intermediate transfer belt 22 is stretched. The secondary transfer outer roller 16 is supplied with a secondary transfer bias of high voltage and transfers the full-color toner image carried by the intermediate transfer belt 22 to the sheet S that has reached the secondary transfer position T2 (secondary transfer). The belt cleaner 29 removes a toner remaining on the intermediate transfer belt 22 after the secondary transfer.

The fixing unit 30 is a fixing unit disposed downstream of the secondary transfer position T2. The fixing unit 30 includes a fixing roller (or a cylindrical heating film) and a pressure roller, and fixes the toner image on the sheet S by heating and pressing the sheet S on which the toner image has been transferred. The sheet S that has passed through the fixing unit 30 is discharged to the outside of the image forming apparatus 100 (e.g. to a discharge tray (not illustrated).

When double-side printing is executed, the sheet S on which the toner image is formed on the first surface is conveyed to the conveyance path 17. Therefore, the sheet S reverses the traveling direction and enters the conveyance path 18 for double-side printing. The sheet S returns to the conveyance path 12 with its front and back sides reversed. The toner image is transferred to the second surface of the sheet S at the secondary transfer position T2.

The fixing unit 30 fixes the toner image on the second surface of the sheet S by heating and pressing the sheet S again. Then, the sheet S is discharged to the outside of the image forming apparatus 100.

The operation unit 40 is an operation unit that provides a user interface to a user of the image forming system 1. The operation unit 40 includes, for example, a touch panel 41. The touch panel 41 displays an image and information according to control by a main control unit 101 described later, and accepts a touch input by a user. The operation unit 40 may include an output device (e.g. a liquid crystal display or a speaker) and an input device (e.g. a button, a switch, a keypad, or a microphone) instead of (or in addition to) the touch panel 41.

The main control unit 101 is a control unit that controls the overall operation of image forming apparatus 100. For example, the main control unit 101 controls the image forming unit 20 to form an image on the sheet S based on input image data received from an external device when the execution of the print job is instructed. The external device here may be, for example, a personal computer (PC) or an external controller. Although not shown in FIG. 1, the image forming apparatus 100 may further include a document reading unit. That is, the image forming apparatus 100 may be a multifunction peripheral. In this example, when the execution of the copy job is instructed, the main control unit 101 controls the image forming unit 20 to form an image on the sheet S based on the read image data generated by the scanner unit reading the document.

### 1-2. Foil Printer (Foil Processing Equipment)

The foil printer 120 includes a conveyance roller 111, a discharge roller 112, a heating roller 121, a pressure roller 122, a supply reel 131, a retrieval reel 132, and a discharge tray 140.

The conveyance roller 111 receives the sheet S on which the toner image is formed, and feeds the sheet S to an adhering position T3. At the adhering position T3, the heating roller 121 and the pressure roller 122 are disposed so as to face each other. The supply reel 131 is wound with a foil sheet 150 composed of foil and a film-shaped holding member for holding the foil. The leading end of the foil sheet 150 is fixed to the retrieval reel 132.

The supply reel 131 and the retrieval reel 132 suspend the foil sheet 150 via the lower surface of the heating roller 121 while maintaining a predetermined tension so as not to cause wrinkles in the foil sheet 150. Although not shown in FIG. 1, the foil printer 120 may include additional suspension rollers to stably maintain the tension of the foil sheet 150. The supply reel 131 rotates in the clockwise direction in the drawing to supply the foil sheet 150 to the adhering position T3. The heating roller 121 heats the sheet S that has reached the adhering position T3. Accordingly, a result, at least one type of toner used as a glue (adhesive) among the toners constituting the toner image melts. The pressure roller 122, together with the heating roller 121, presses the foil sheet 150 against the sheet S. As a result, the melted toner acts as a glue, and the foil on the foil sheet 150 is adhered to the sheet S via the toner. The retrieval reel 132 rotates in the counterclockwise direction in the drawing, and winds up the foil sheet 150. At this time, the foil on the foil sheet 150 is peeled off from the support member and adhered to the sheet S to form an image of the foil on the sheet S. The discharge roller 112 discharges the sheet S that has passed through the adhering position T to the discharge tray 140.

### 1-3. Foil

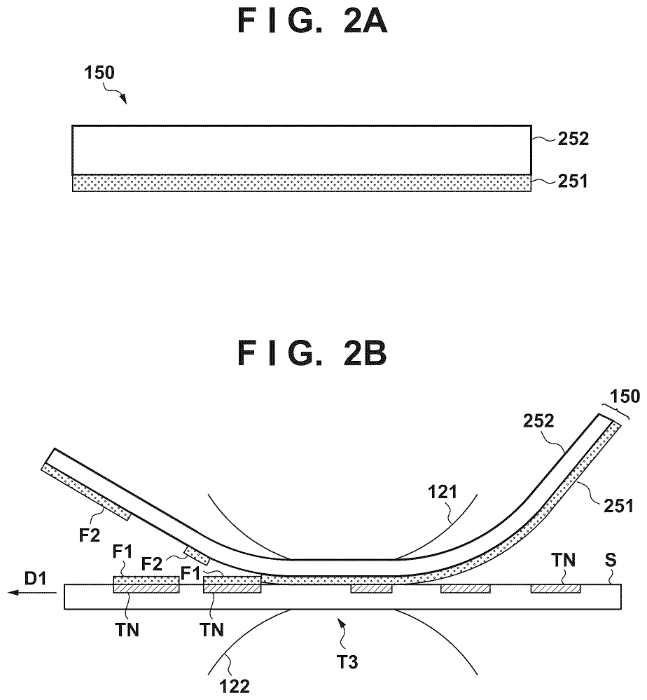

FIG. 2A shows an example of the construction of the foil sheet 150. The foil sheet 150 includes a foil layer 251 and a backup layer 252. The foil layer 251 is a sheet-like layer made of a metal material. The metal material of the foil layer 251 may be, for example, aluminum, tin, silver, copper, chromium, nickel, gold, or iron, or an alloy of two or more thereof (e.g., nickel-chromium steel, bronze, or aluminum bronze). The backup layer 252 is a sheet-like layer made of resin that supports the foil layer 251. The resin material of the backup layer 252 may be, for example, polyethylene terephthalate (PET), polyethylene naphthalate (PEN), polypropylene (PP), polyether sulfone (PES), or polyimide (PI).

### 1-4. Formation of Foil Images

FIG. 2B shows an enlarged view of the vicinity of the adhering position T3 while the foil printer 120 is operating. In this example, the heating roller 121 positioned on the adhering position T3 and the pressure roller 122 positioned below the adhering position T3 nip the sheet S on which the toner image TN is formed and the foil sheet 150. The heating roller 121 and the pressure roller 122 rotate according to the rotation of the retrieval reel 132 driven by a motor (not illustrated), and convey the sheet S and the foil sheet 150 toward the conveyance direction D1.

The surface temperature of the heating roller 121 is controlled so that the temperature of the toner in the toner image TN reaches the melting point. This temperature is, for example, from 140° C. to 180° C. When the temperature of the toner reaches the melting point at the adhering position T3, the toner melted and increased in viscosity acts as a glue. The toner image TN is further pressed by the pressure roller 122 to adhere to the foil layer 251 of the foil sheet 150. Therefore, when the sheet S and the foil sheet 150 pass through the adhering position T3, the foil F1 of the foil layer 251 in contact with the toner image TN is peeled off from the backup layer 252 while being adhered to the sheet S. On the other hand, the foil F2 of the foil layer 251 that is not in contact with the toner image TN is retrieved by the retrieval reel 132 while remaining on the backup layer 252 without being adhered to the sheet S. Consequently, the foil layer 251 is selectively transferred to the sheet S according to the pattern of the toner image TN on the sheet S to form a foil image on the sheet S.

### 1-5. Relationship Between Jams and Margins

The conveyance direction D1 is also a direction in which the sheet S is inserted into the foil printer 120. If the margin provided at the leading end of the sheet S is not sufficiently large in the conveyance direction D1, the sheet S is jammed in the foil printer 120. This is because the foil layer 251 and the sheet S cannot be successfully peeled from the backup layer 252. Therefore, the size of the margin on the leading end side needs to be a value such that separating is successful. For example, the leading end margin may be equal to or larger than 1 mm. However, the size of the required leading end margin may vary depending on the type, size, and use environment of the sheet S. Therefore, the length of the leading end margin may be equal to or greater than 5 mm. Note that the length of the margin on the leading end side may be designated in the instruction manual of the foil printer 120.

### 1-6. Foil Printing Mode

The type of sheet S that can be formed a toner image with the image forming apparatus 100 (e.g., size, thickness, basis weight, presence or absence of surface coating, etc.) may not match the type of sheet S that can be subjected to foil processing by the foil printer 120. Therefore, there is a possibility that the foil printer 120 cannot use the sheet S on which images are printed by the image forming apparatus 100 in a normal printing mode. Therefore, the image forming apparatus 100 may be provided with a foil printing mode for forming a toner image on the sheet S that can be subjected to foil processing by the foil printer 120.

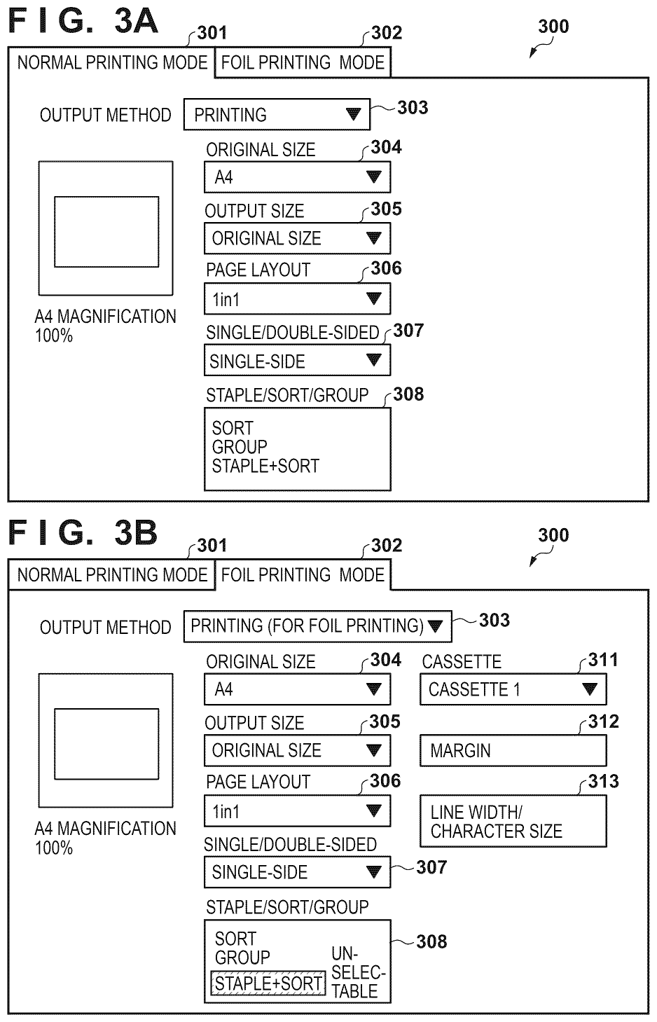

FIG. 3A and FIG. 3B are diagrams illustrating a user interface (UI) 300 for instructing the image forming apparatus 100 to execute a print job from the operation unit 40 or PC. A tab 301 is a setting screen for the normal printing mode. A tab 302 is a setting screen for the foil printing mode. In FIG. 3A, the normal printing mode is selected. In FIG. 3B, the foil printing mode is selected.

A menu 303 is a menu for designating an image output method (e.g. printing, transmitting, and storing). A menu 304 is a menu for selecting a document size. A menu 305 is a menu for selecting an output size of an image for the sheet S. A menu 306 is a menu for selecting a page layout (e.g., 1in1, 2in1). A menu 307 is a menu for selecting single-side printing or double-side printing. A setting unit 308 is UI for selecting the presence or absence of stapling (using stapler), the presence or absence of grouping, or the presence or absence of sorting.

As shown in FIG. 3B, a menu 311 is a menu for selecting a sheet cassette. A button 312 is a margin setting button for calling a margin setting UI. A button 313 is a button for calling a UI used to set a line width and a character size.

Note that, it is difficult for the foil printer 120 to apply foil processing to a stapled sheet S. Therefore, in the tab 302 for the foil print mode, selection of stapling in the setting unit 308 is restricted.

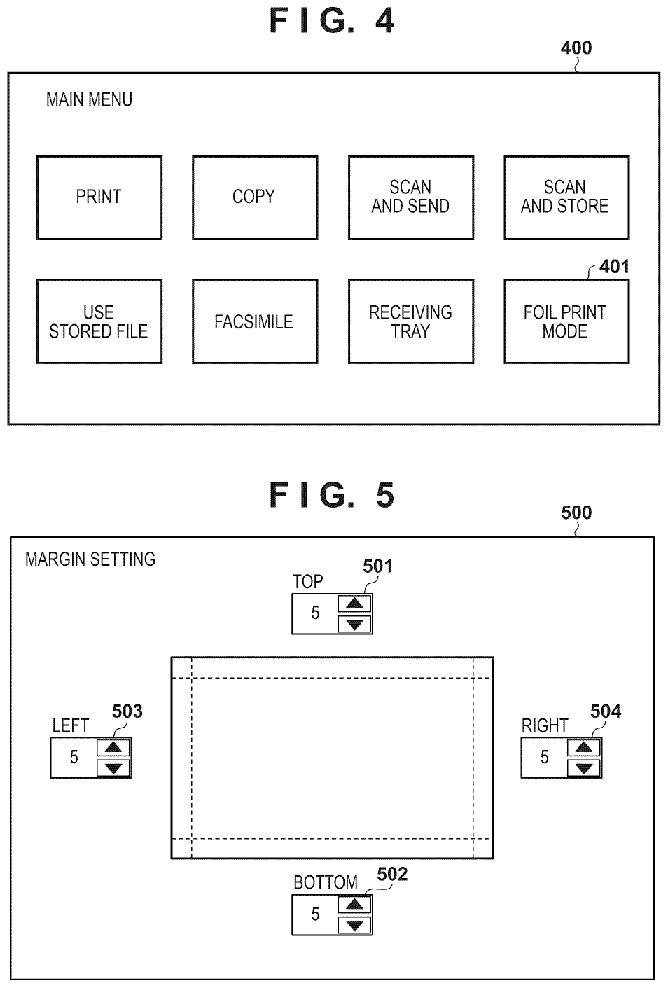

FIG. 4 shows another UI 400 displayed on the operation unit 40. A button 401 is a button for instructing the image forming apparatus 100 to switch from the normal print mode to the foil print mode. When a button 401 is pressed, the operation unit 40 may display a setting screen such as the tab 302.

FIG. 5 shows a margin setting UI 500. The margin setting units 501, 502, 503, and 504 are UIs for setting the sizes (lengths) of the margins provided on the four sides (edges) of the sheet S. The margin setting units 501, 502, 503, and 504 may include a display area for displaying the value of the current margin, a button for increasing the margin, a button for decreasing the margin, and the like. The user can manually set the margin by operating the margin setting units 501, 502, 503, and 504. The margin set here may be referred to as a “set margin”. The set margin of each side may be given an initial value in advance. The initial value may be, for example, a margin value that is less likely to cause paper jam in the foil printer 120. In this case, it would be possible to save the user from having to change the margin setting.

The margin setting units 501, 502, 503, and 504 may be arranged around a rectangular simulating the sheet S. In addition, a broken line indicating an edge portion of the margin may be displayed inside the rectangular simulating the sheet S. The operation unit 40 may move the display position of the broken line in accordance with the margin values set in the margin setting units 501, 502, 503, and 504.

### 1.7 Controller (Control System)

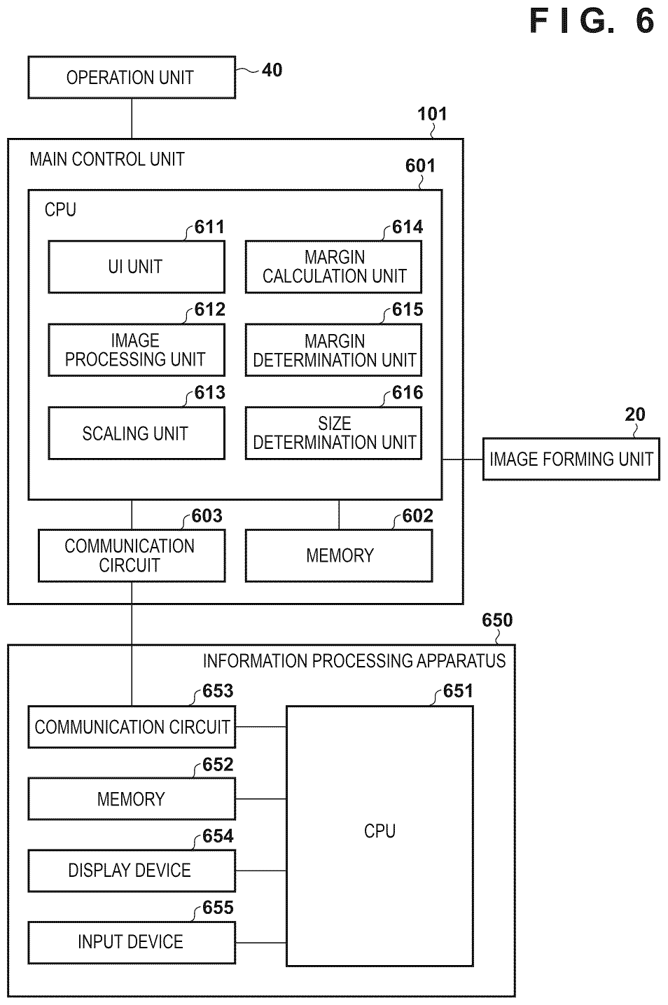

FIG. 6 shows a controller of the image forming system 1. A motor and a power supply other than the load illustrated are connected to the main control unit 101, since they are not the present invention, their illustration and description are omitted.

The main control unit 101 includes, for example, a central processing unit (CPU) 601, a memory 602, and a communication circuit 603. The memory 602 may include a read only memory (ROM), a random access memory (RAM), and the like. The CPU 601 implements various functions by executing a control program stored in a ROM area of the memory 602.

A UI unit 611 displays information on the operation unit 40 and accepts an instruction and information input by a user through the operation unit 40. An image processing unit 612 expands print data described by a page description language (PDL) into image data, converts a color space of the image data, and so on. Further, the image processing unit 612 may enlarge or reduce an image or rotate an image. A scaling unit 613 calculates a scaling factor of the image data. A margin calculation unit 614 calculates the margin reserved on the four sides of the sheet S. A margin determination unit 615 determines whether the margin is smaller than a threshold value. A size determination unit 616 determines whether or not the size of the sheet S is smaller than a specified value. These functions may be implemented individually by an integrated circuit provided outside the CPU 601 and can communicate with the CPU 601. The communication circuit 603 is an interface circuit used by the CPU 601 to communicate with the foil printer 120 and the information processing apparatus 650.

The image forming apparatus 100 may optionally communicate with the information processing apparatus 650. A CPU 651 of the information processing apparatus 650 executes an operating system (OS) and a printer driver stored in a memory 652 and controls the image forming apparatus 100. The CPU 651 communicates with the image forming apparatus 100 through a communication circuit 653. The memory 652 is a storage device that may include a hard disk drive, a solid state drive (SSD), or the like in addition to ROM, and RAM. The display device 654 is a liquid crystal display or the like that displays a UI 300, a margin setting UI 500, and the like. An input device 655 may include a keyboard, a pointing device, a touch sensor, a microphone, and the like.

### 1-8. Control in Foil Print Mode

In electrophotographic type image forming apparatus such as the image forming apparatus 100, the margins are set automatically by the CPU 601 or the CPU 651 (auto-setting) or manually by the user (manual setting). Here, the term “automatic” refers to execution without input by a user or execution by a slight input (assistance) by a user.

As described above, when the sheet S is fed into the foil printer 120 with a side where the margin of the sheet S (hereinafter, referred to as a margin-on-paper) is insufficient as a leading edge, there is a possibility that a paper jam occurs in the foil printer 120. Therefore, the margin-on-paper is required to be sufficiently large.

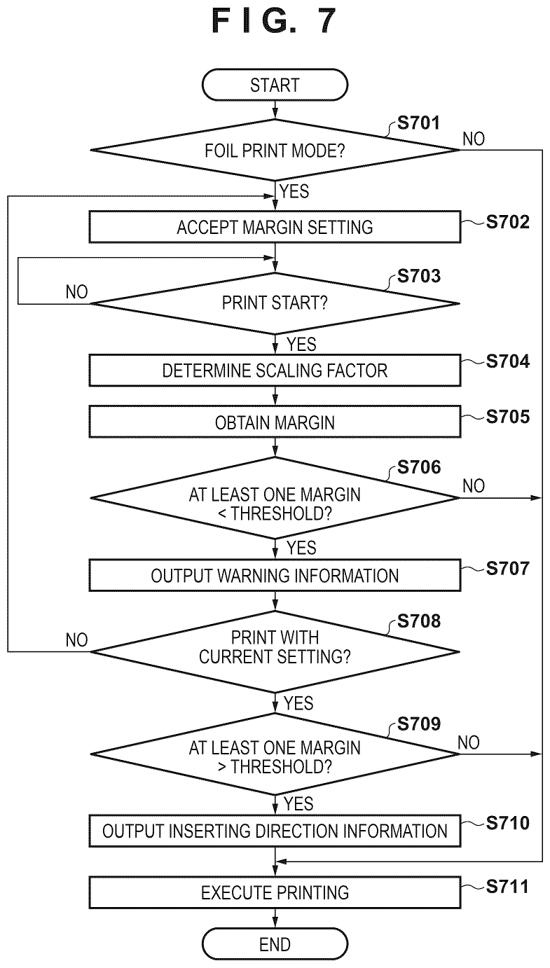

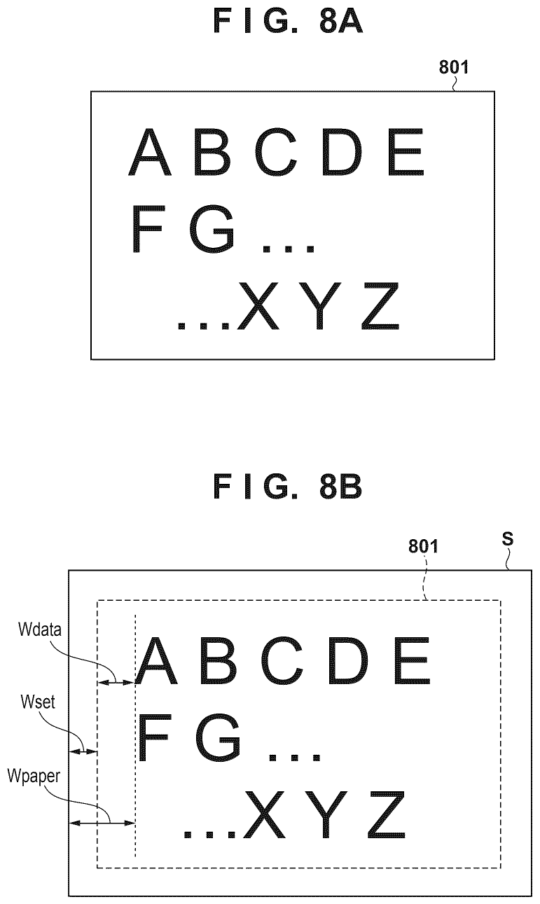

FIG. 7 shows a control method for reducing the frequency of paper jams in the foil printer 120. FIG. 8A shows an example of the image data. When a print job is input from the information processing apparatus 650 or a print instruction is input from the operation unit 40, the CPU 601 executes an image forming program stored in the memory 602. The CPU 601 executes the following process according to the image forming program.

In the step S701, the CPU 601 determines whether the foil print mode is selected as the print mode. If the foil print mode is selected, the CPU 601 advances the process from the step S701 to the step S702. If the normal print mode is selected, the CPU 601 advances the process from the step S701 to the step S711. In the step S711, the CPU 601 controls the image forming unit 20 to form a normal image on the sheet S. Here, a normal image is an image prepared by a user and not subjected to foil processing.

In the step S702, the CPU 601 displays the margin setting UI 500 on the operation unit 40, and accepts the margin setting input by the user. The CPU 601 stores the margin value (set margin Wset) set by the user in a RAM area of the memory 602.

In the step S703, the CPU 601 determines whether or not a print instruction has been given through the operation unit 40. For example, the CPU 601 may detect that a print button (not shown) provided in the margin setting UI 500 is pressed. If printing is instructed, the CPU 601 advances the process from the step S703 to the step S704.

In the step S704, the CPU 601 (scaling unit 613) reads the set margin Wset from the memory 602, and determines the scaling factor based on the set margin Wset, the size of the image data, and the size of the sheet S. The scaling factor is determined, for example, so that all of the toner images based on the image data can be transferred within the remaining area acquired by removing four margins from the sheet S. Note that scaling refers to enlarging or reducing the size of a toner image based on image data. The CPU 601 stores the scaling factor in the RAM area of the memory 602. The image processing unit 612 scales the image data according to the scaling factor.

In the step S705, the CPU 601 (margin calculation unit 614) acquires the margin-on-paper Wpaper based on the set margin Wset, the margin data Wdata in the image data, and the scaling factor. FIG. 8B shows the relationship between the set margin Wset, the margin data Wdata, and the margin-on-paper Wpaper. The set margin Wset indicates a distance from each side to a corresponding side of the toner image 801 based on the image data on the sheet S. The margin data Wdata indicates a distance between an edge portion of the toner image 801 based on the image data and an actual toner image having a predetermined density. The margin-on-paper Wpaper indicates a distance from the side (edge) of the sheet S to an actual toner image having a predetermined density.

Here, four margins corresponding to the four sides are denoted as Wpaper_top, Wpaper_bottom, Wpaper_right, and Wpaper_left, and are calculated from the following expressions and stored in the memory 602.

$$Wpaper\_top = Wset\_top + Wdata\_top \times Ay \qquad Eq 1$$

$$Wpaper\_bottom = Wset\_bottom + Wdata\_bottomp \times Ay \qquad Eq 2$$

$$Wpaper\_right = Wset\_right + Wdata\_right \times Ax \qquad Eq 3$$

$$Wpaper\_left = Wset\_left + Wdata\_left \times Ax \qquad Eq 4$$

Here, Ax indicates a scaling factor in a lateral direction. Here, Ay indicates a scaling factor a vertical direction. Top, bottom, right, left assigned to the respective variables throughout the embodiment indicate the top side, the bottom side, the right side, and the left side, respectively.

In the step S706, the CPU 601 (margin determination unit 615) determines whether at least one margin among the four margins-on-paper Wpaper is smaller than a threshold. When all the margins-on-paper Wpaper are greater than or equal to the threshold Wth, the CPU 601 advances the process from the step S706 to the step S711 to form a toner image on the sheet S. On the other hand, if at least one margin is smaller than the threshold Wth, the CPU 601 processes from the step S706 to the step S707.

In the step S707, the CPU 601 (UI unit 611) outputs the warning information on the operation unit 40 or the display device 654 of the information processing apparatus 650. The warning information includes, for example, a message or an image indicating that there is a shortage of margin-on-paper or that a jam may occur in the foil printer 120.

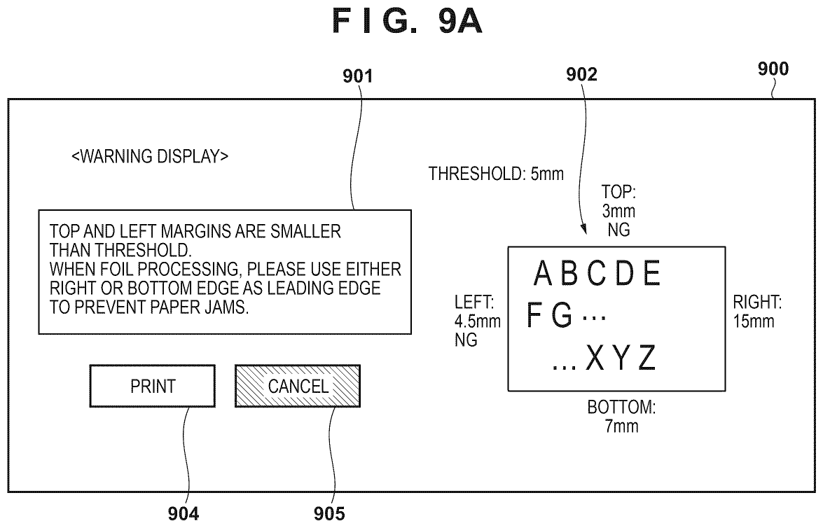

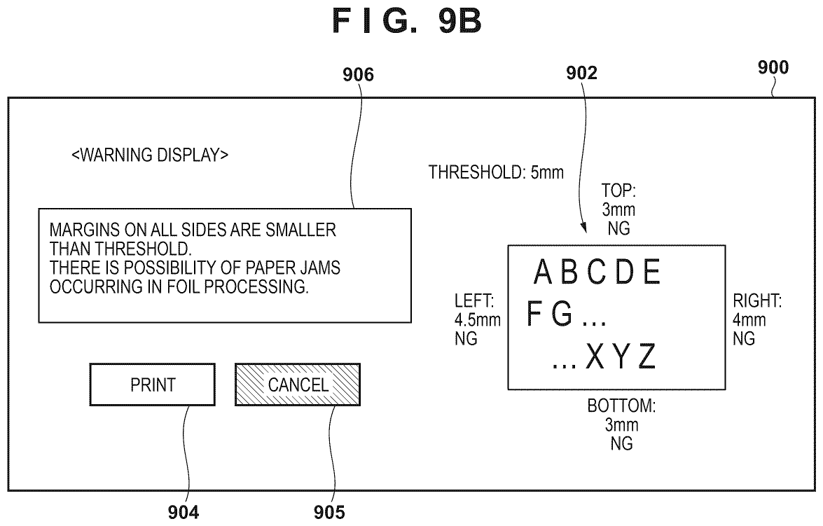

FIG. 9A and FIG. 9B show a warning UI 900 indicating warning information. As shown in FIG. 9A, the warning UI 900 may present a warning message 901 indicating that there is a shortage of margin-on-paper Wpaper provided on at least one or more sides. The warning message 901 may include information indicating a side where a margin is insufficient, a direction in which the sheet S is inserted for suppressing paper jams, and the like. FIG. 9B shows a warning message 906 when all four margins-on-paper Wpapper are below a threshold Wth. In this case, the warning message 906 does not include information indicating the insertion direction. This is because the margin-on-paper is insufficient even if any of the four sides is adopted as the leading edge in the insertion direction.

A warning image 902 may include a numerical value of a set margin or a margin-on-paper Wpaper provided on each side, and text (e.g. NG) or a mark indicating which side margin is insufficient. A print button 904 is a button for instructing to execute printing with the current margin setting. A cancel button 905 is a cancel button for resetting the margin.

In the step S708, the CPU 601 determines whether to print with the current setting. If the print button 904 is pressed, the CPU 601 advances the process from the step S708 to the step S709. On the other hand, when the cancel button 905 is pressed, the CPU 601 advances the process from the step S708 to the step S703 and displays the margin setting UI 500 on the operation unit 40, again.

In the step S709, the CPU 601 (margin determination unit 615) determines whether at least one margin among the four margins-on-paper Wpaper is greater than the threshold Wth. Note that, the CPU 601 (margin determination unit 615) determines whether at least one margin among the four margins-on-paper Wpaper is greater than or equal to the threshold Wth. If at least one margin is greater than the threshold Wth, the CPU 601 processes from the step S709 to the step S710. If all four margins-on-paper are not greater than the threshold Wth, the CPU 601 processes from the step S709 to the step S711.

In the step S710, the CPU 601 (UI unit 611) outputs insertion direction information on the operation unit 40 or the display device 654 of the information processing apparatus 650. The insertion direction information includes text or an image indicating that a side on which a sufficiently large margin-on-paper is reserved should be a leading edge in the insertion direction.

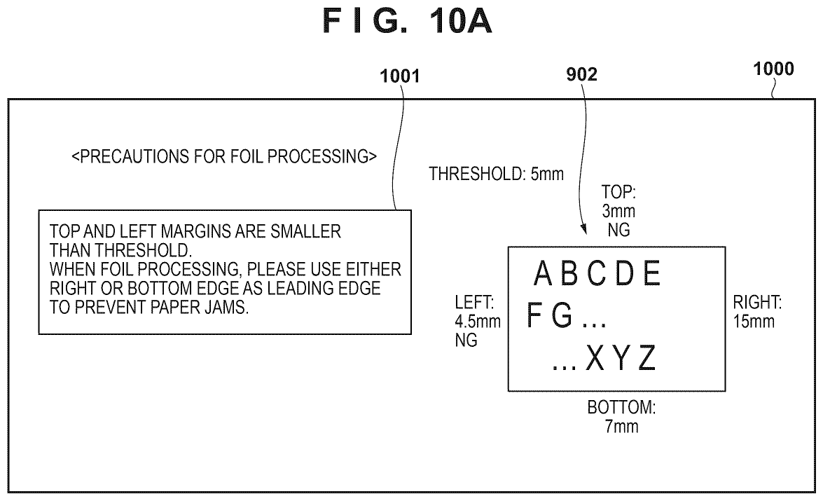

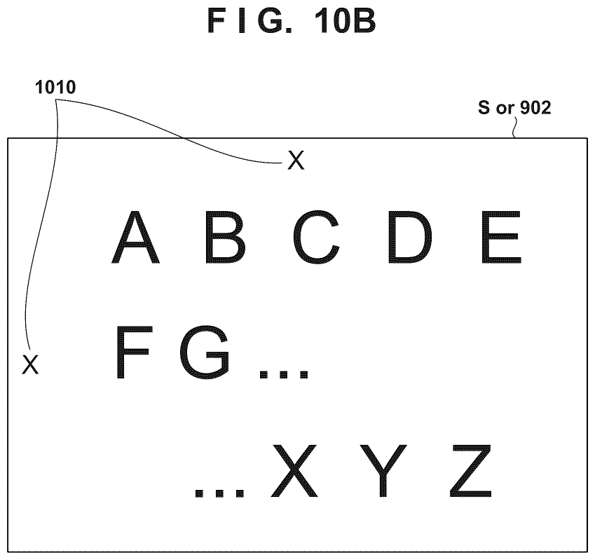

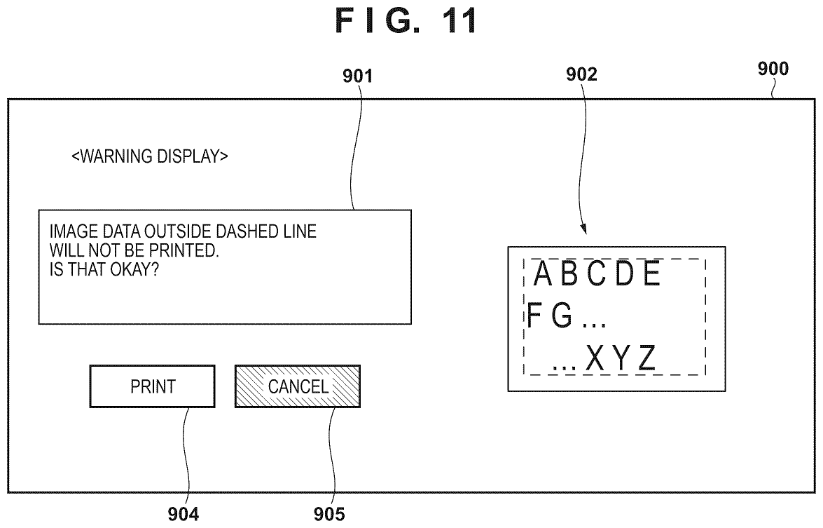

FIG. 10A shows an insertion guidance UI 1000 indicating the insertion direction information. The insertion guidance UI 1000 includes a warning image 902 and a guide message 1001. The guide message 1001 may include text or an image indicating a direction (e.g. a leading edge) in which the sheet S is inserted with respect to the foil printer 120.

FIG. 10B shows the warning image 902 or an image formed on the sheet S. A mark may be printed on the sheet S near the edge that should not be the leading edge. A mark may be displayed, on the warning image 902, on the sheet S near the edge that should not be the leading edge.

In the step S711, the CPU 601 controls the image forming unit 20 to execute printing onto the sheet S.

According to a first embodiment, warning information is output to the user based on the margin-on-paper Wpaper. Accordingly, the frequency of a paper jam in the foil printer 120 caused by the shortage of the margin-on-paper provided on the side (edge portion) of the sheet S serving as the leading edge in the insertion direction will be reduced.

### 1-9. Modification

In the above-described embodiment, the scaling factor is calculated so that the entire toner image based on the image data fits within the remaining area acquired by subtracting the set margin Wset from the sheet S. However, this is only an example. The magnification of the image data may not be changed. For example, in an area where the toner image based on the image data and the set margin Wset overlap each other, the image processing unit 612 may adjust the image data so that the toner image is not printed.

FIG. 11 illustrates another example of a warning UI 900. The warning image 902 includes an image for warning the user that a part of the toner image based on the image data is missing. The warning message 902 includes text for warning the user that a part of the toner image based on the image data is missing.

### II. Second Embodiment

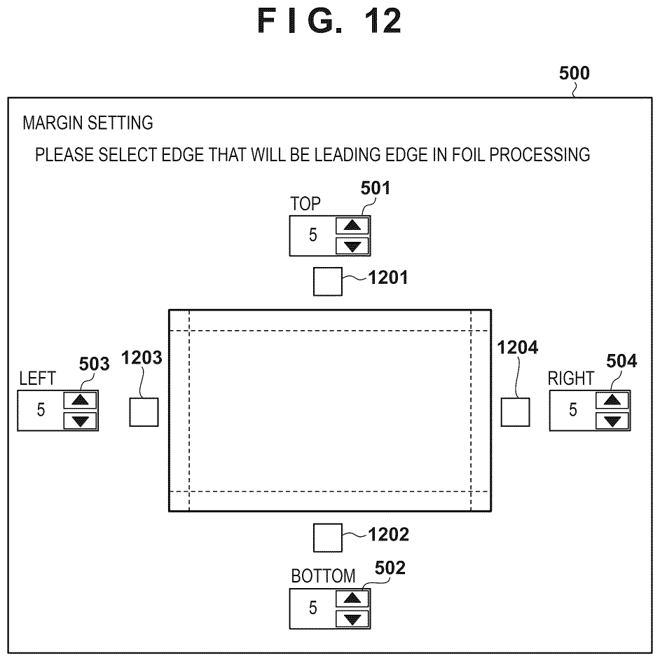

FIG. 12 illustrates another example of a margin setting UI 500. The image forming apparatus 100 or the information processing apparatus 650 may accept insertion direction information regarding a direction in which the sheet S is inserted into the foil printer 120 through the margin setting UI 500. A checkbox 1201 is a UI for selecting the top side as the leading edge. A checkbox 1202 is a UI for selecting the bottom side as the leading edge. A checkbox 1203 is a UI for selecting the left side as the leading edge. A checkbox 1204 is a UI for selecting the right side as the leading edge.

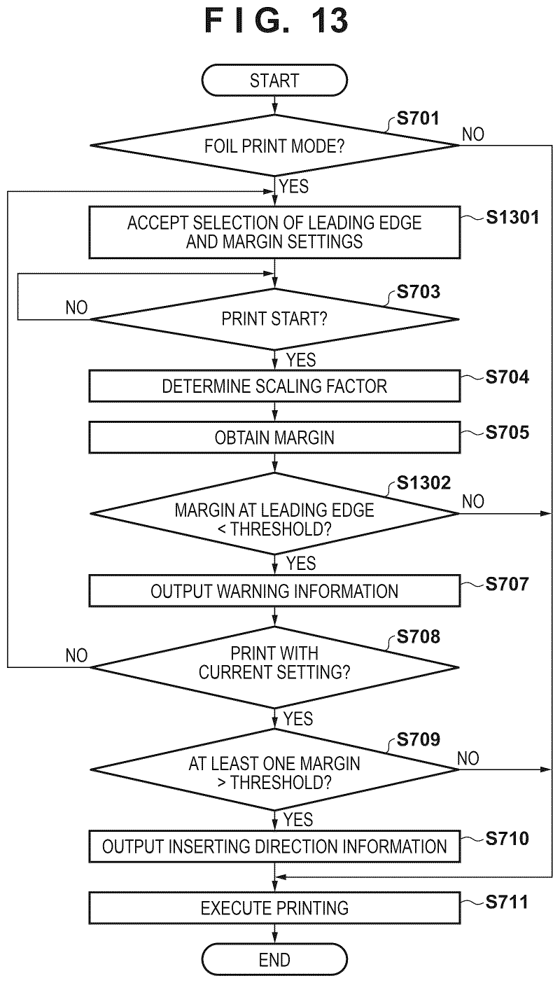

FIG. 13 shows a control method according to the second embodiment. Note that, the same reference numerals are given to the steps described above, and the description thereof will be omitted. The step S702 is substituted with the step S1301. The step S706 is substituted with the step S1302.

In the step S1301, the CPU 601 (UI unit 611) accepts the leading edge and the set margin Wset in the insertion direction, which are input through the margin setting UI 500 displayed on the operation unit 40. The insertion direction information indicating the leading edge and the set margin Wset are stored in the memory 602. After that, the CPU 601 advances the process from the step S1301 to the step S703. Moreover, the CPU 601 advances the process from the step S705 to the step S1302.

In the step S1302, the CPU 601 (margin determination unit 615) checks whether or not the margin-on-paper Wpaper reserved at the leading edge side of the sheet S is smaller than the threshold Wth. It may be determined whether the margin-on-paper Wpaper is greater than or equal to the threshold Wth. If the margin-on-paper Wpaper is greater than or equal to the threshold Wth, the CPU 601 processes from the step S1302 to the step S711. If the margin-on-paper Wpaper is smaller than the threshold Wth, the CPU 601 processes from the step S1302 to the step S707.

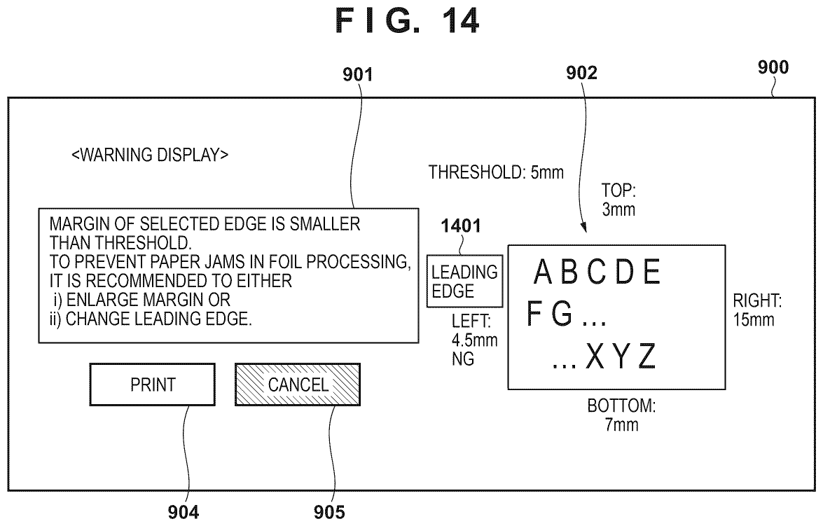

FIG. 14 illustrates another example of a warning UI 900 displayed in the step S707. A leading mark 1401 includes an image or text indicating the edge designated as the leading edge of the four edges. The warning message 901 includes a message indicating that the margin-on-paper Wpaper designated as the leading edge is smaller than the threshold Wth. Further, the warning message 901 may include a message that suggests a way to reduce jams. In this example, enlarging the margin or changing the leading edge is shown.

If the print button 904 is pressed, the CPU 601 advances the process from the step S708 to the step S709. If the cancel button 905 is pressed, the CPU 601 advances the process from the step S708 to the step S1310. Therefore, the margin setting UI 500 shown in FIG. 13 is displayed on the operation unit 40, and the user can change the leading edge or enlarge the set margin Wset. Note that, the insertion direction information selected by the user is displayed in the step S710.

### III. Third Embodiment

In the second embodiment, when there is insufficient margin-on-paper Wpaper reserved on the edge designated as the leading edge, the user can adjust the margin by returning from the warning UI 900 to the margin setting UI 500. However, the margin may be adjusted in a simpler way for the user.

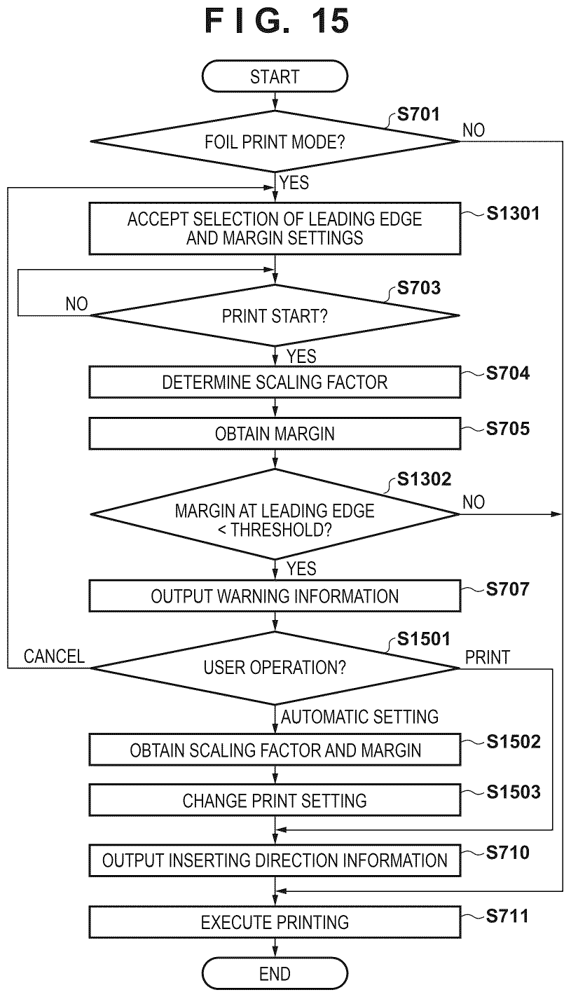

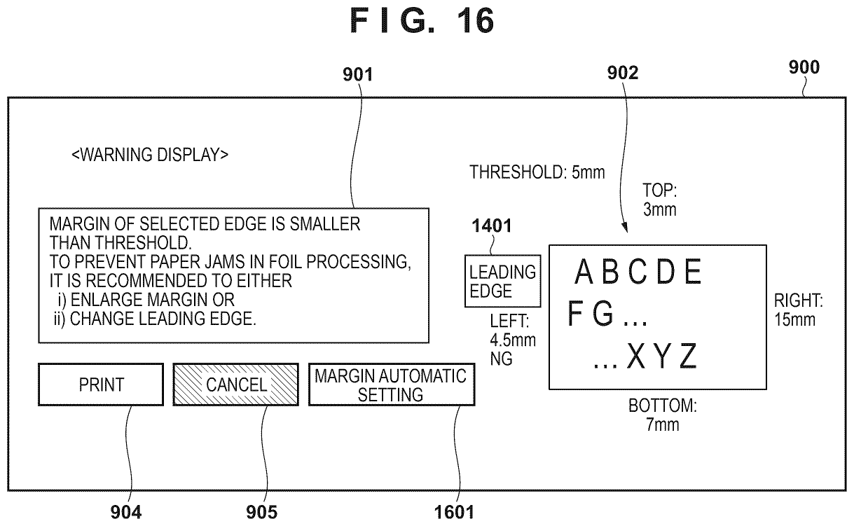

FIG. 15 shows a control method according to the third embodiment. Note that, the same reference numerals are given to the steps described above, and the description thereof will be omitted. The step S708 and the step S709 are substituted with the step S1501 to the step S1503.

In the step S708, the user could press the cancel button 905 to return to the step S1301 (manual margin adjustment, re-designation of the leading edge) or press the print button 904 to advance to the step S711 (print with the current settings). In the step S1501, the user is allowed to select the automatic-setting of the margin.

FIG. 16 shows a warning UI 900 according to a third embodiment. The warning UI 900 includes an automatic margin setting button 1601. The user can adjust the margin in the warning UI 900 by pressing the automatic margin setting button 1601.

On the step S1501, the CPU 601 (UI unit 611 advances the process from the step S1501 to the step S1502 when it detects that the automatic margin setting button 1601 has been pressed.

In the step S1502, the CPU 601 (scaling unit 613 and margin calculation unit 614) acquires the set margin Wset and the scaling factor Ax, Ay so that the margin-on-paper Wpaper of the edge selected as the leading edge is greater than or equal to the threshold Wth. Here, the margin-on-paper Wpapper can be calculated using the equations Eq1 to Eq4. Therefore, when the margin-on-paper Wpapper is replaced with the threshold Wth, the following equations are obtained.

$$Wth = < Wset\_top + Wdata\_top \times Ay \qquad Eq 5$$

$$Wth = < Wset\_botom + Wdata\_bottom \times Ay \qquad Eq 6$$

$$Wth = < Wset\_right + Wdata\_right \times Ax \qquad Eq 7$$

$$Wth = < Wset\_left + Wdata\_left \times Ax \qquad Eq 8$$

Thus, the CPU 601 adjusts the set margin Wset or the scaling factor Ax, Ay so that the above equations are satisfied for the side selected by the user. Note that, since there are two variables in the respective equations, constraints may be imposed on one or both of the set margin Wset and the scaling factor Ax, Ay. For example, the set margin Wset may be maintained and only the scaling factor Ax, Ay may be adjusted. The scaling factor Ax, Ay may be maintained and only the set margin Wset may be adjusted. Alternatively, the set margin Wset may be adjusted so that the scaling factor Ax, Ay is maximized.

In the step S1503, the CPU 601 (the scaling unit 613 and the margin calculation unit 614) updates the set margin Wset and the scaling factor Ax, Ay held in the memory 602 to the new set margin Wset and the scaling factor Ax, Ay obtained in the step S1502. After that, the CPU 601 advances the process from the step S1503 to the step S710.

In the third embodiment, the set margin is automatically changed on the warning UI 900. A UI (up/down buttons) or the like may be added to the warning UI 900 such that the user can manually adjust the set margin.

### IV. Fourth Embodiment

The size of the sheet S that can be inserted into the foil printer 120 may be input by the user in the image forming apparatus 100 or the information processing apparatus 650. Note that, if a certain side of the four sides of the sheet S is selected as the leading edge, the sheet S may not be inserted into the foil printer 120. In this case, the UI unit 611 may provide a leading edge designating UI in which the user cannot select a side which is not recommended to be selected as the leading edge among the four sides. Accordingly, the sheet S will not be inserted into the foil printer 120 with the side that is not recommended as the leading edge. As a result, reprinting of the toner image will also be suppressed.

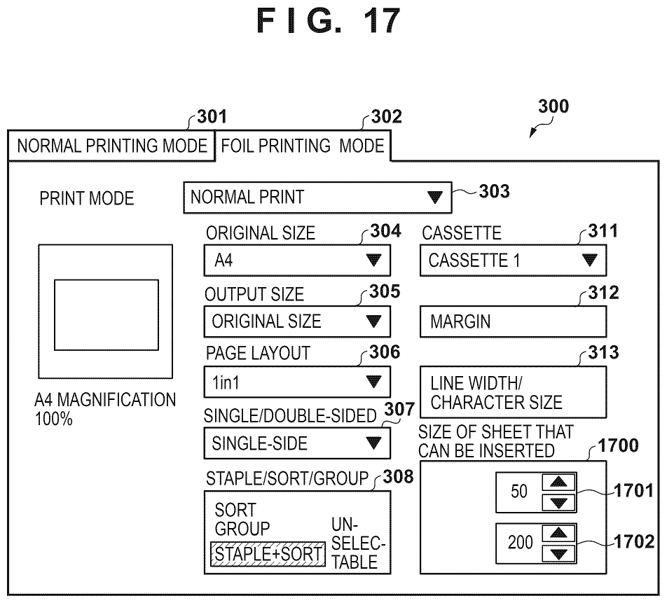

FIG. 17 shows another examples of the UI 300. The UI 300 includes a size setting unit 1700 that accepts the setting of the size of the sheet S that can be inserted. The size setting unit 1700 may include an adjustment button 1701 that accepts the setting of the size on the short side and an adjustment button 1702 that accepts the setting of the size on the long side. This allows the user to input, to the image forming apparatus 100, the size of the sheet S that can be inserted into the foil printer 120. Note that, the CPU 601 may communicate with the foil printer 120 to acquire the size of the sheet S that can be inserted. The CPU 601 may search through the communication circuit 603 for a Web page containing a specification document or an instruction manual of the foil printer 120 to acquire the size of the sheet S that can be inserted.

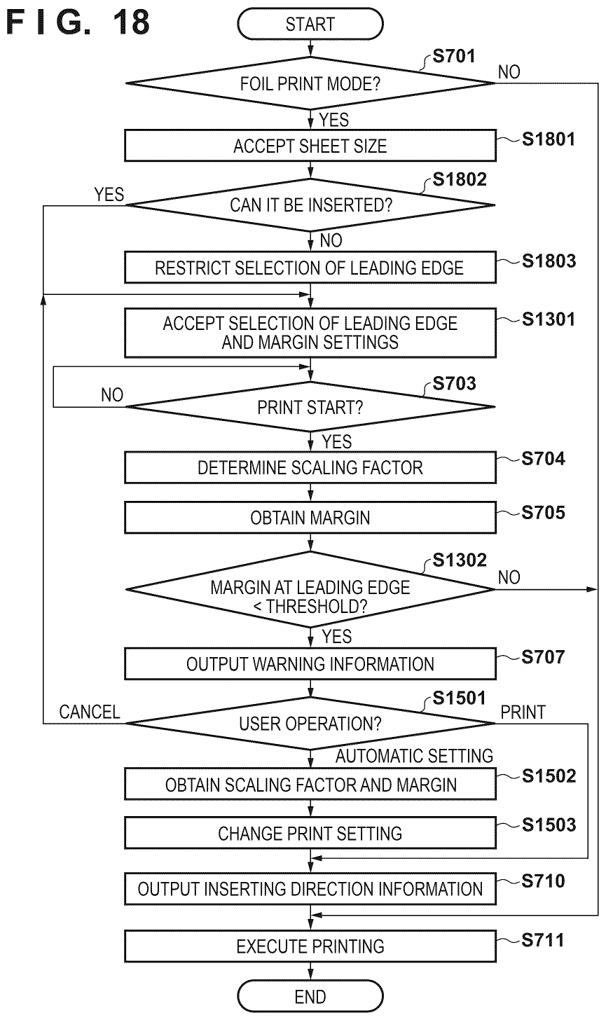

FIG. 18 shows a control method according to the fourth embodiment. Here, the step S1801 to the step S1803 is added between the step S701 and the step S1301 shown in FIG. 15. Note that descriptions of the described steps are omitted. If the foil print mode is determined to be selected, the CPU 601 advances the process from the step S701 to the step S1801.

In the step S1801, the CPU 601 displays the UI 300 on the operation unit 40 and accepts the size of the sheet S that can be inserted into the foil printer 120. The size information indicating the input size is stored in the memory 602.

In the step S1802, the CPU 601 (size determination unit 616) compares the size that can be inserted with the lengths of the respective sides of the sheet S set in the image forming apparatus 100 to determine whether or not the sheet S can be inserted into the foil printer 120. If the sheet S can be inserted into the foil printer 120, the CPU 601 skips the step S1803 and advances the process from the step S1802 to the step S1301. If the sheet S cannot be inserted into the foil printer 120, the CPU 601 advances the process from the step S1802 to the step S1803.

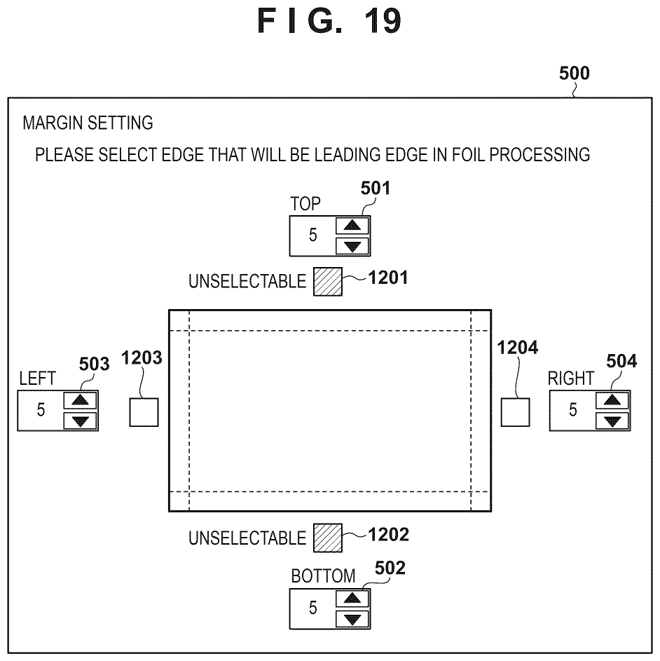

In the step S1803, the CPU 601 (UI unit 611) restricts the selection of the leading edge in the margin setting UI 500. FIG. 19 illustrates another example of a margin setting UI 900. In this example, the checkboxes 1201 and 1202 are grayed out, and the user is restricted (prohibited) from selecting the top side and the bottom side as the leading edge. In addition, the checkboxes 1203 and 1204 can be checked, and the user is allowed to select the left side and the right side as the leading edge. After that, the CPU 601 advances the process from the step S1803 to the step S1301.

According to the fourth embodiment, the side that can be selected as the leading edge is clearly shown to the user based on the size that can be inserted. That is, the user is restricted from selecting an edge that cannot be selected as the leading edge. Accordingly, the formation of a toner image on the sheet S which cannot be inserted into the foil printer 120 is suppressed, and the frequency of reprinting will also be reduced.

### V. Fifth Embodiment

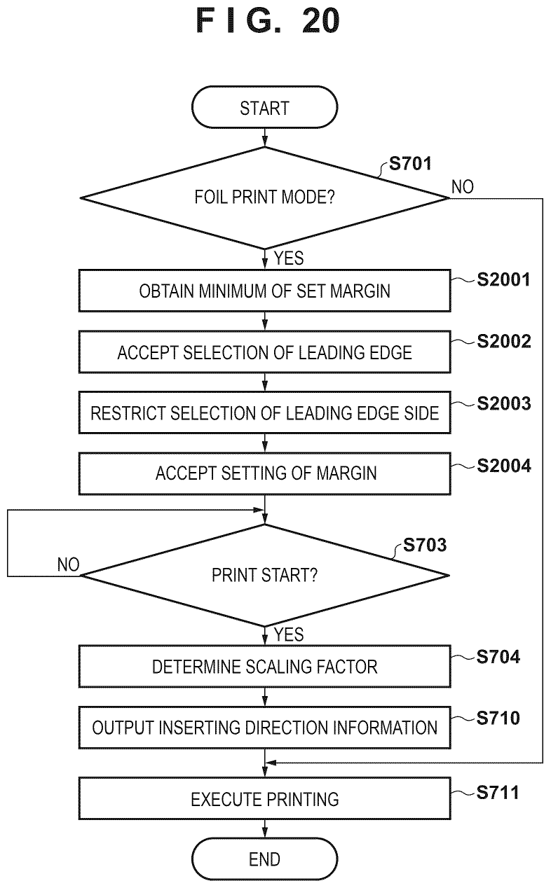

FIG. 20 shows a control method according to the fifth embodiment. In the fifth embodiment, input of the set margin Wset is restricted in the margin setting UI 500 so that the margin-on-paper Wpaper is not smaller than the threshold Wth. The step S702 is substituted with the step S2001 to the step S2004. The step S705 to the step S709 are omitted.

In the step S2001, the CPU 601 obtains the minimum Wset-m of the set margin Wset so that the margin-on-paper Wpaper is greater than or equal to the threshold Wth.

$$Wset ‐ m\_left = Wpaper\_left - Wdata\_left \times Ax \qquad Eq 9$$

$$Wset ‐ m\_right = Wpaper\_right - Wdata\_right \times Ax \qquad Eq 10$$

$$Wset ‐ m\_top = Wpaper\_top - Wdata\_top \times Ax \qquad Eq 11$$

$$Wset ‐ m\_bottom = Wpaper\_bottom - Wdata\_bottom \times Ax \qquad Eq 12$$

In the step S2002, the CPU 601 (UI unit 611) displays the margin setting UI 500 on the operation unit 40 and accepts the selection of the leading edge.

In the step S2003, the CPU 601 (UI unit 611) restricts a margin on the leading edge side on the margin setting UI 500 displayed on the operation unit 40. For example, UI unit 611 prohibits or restricts the set margin Wset from being smaller than the minimum value Wset-m, and allows the set margin Wset greater than or equal to the minimum value Wset-m. The CPU 601 then performs the step S703, the step S704, the step S710 and the step S711. In the fifth embodiment, a margin-on-paper Wpaper that is greater than or equal to the threshold-value Wth is reserved in the step of setting the margin by the user. This eliminates the need for the step S709 from the step S705 related to adjustment of margins and warning.

According to the fifth embodiment, the set margin Wset is subjected to input restriction in the margin setting UI 500. As a result, it is ensured that the margin-on-paper Wpaper is greater than or equal to the threshold Wth.

### VI. Sixth Embodiment

In the first to fifth embodiments, the foil printer 120 was separated from the image forming apparatus 100. However, the foil printer 120 may be coupled (connected) to the image forming apparatus 100.

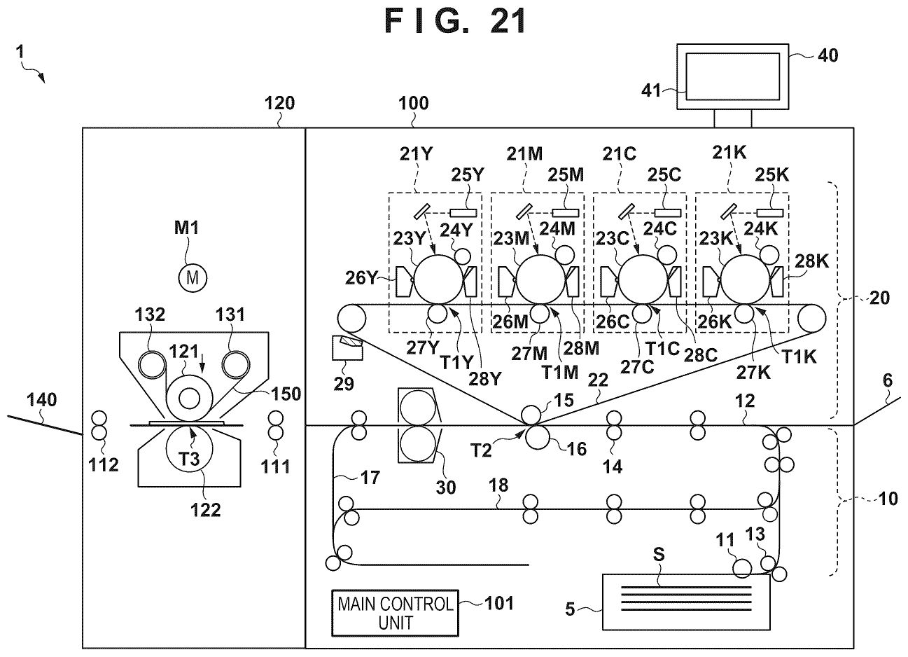

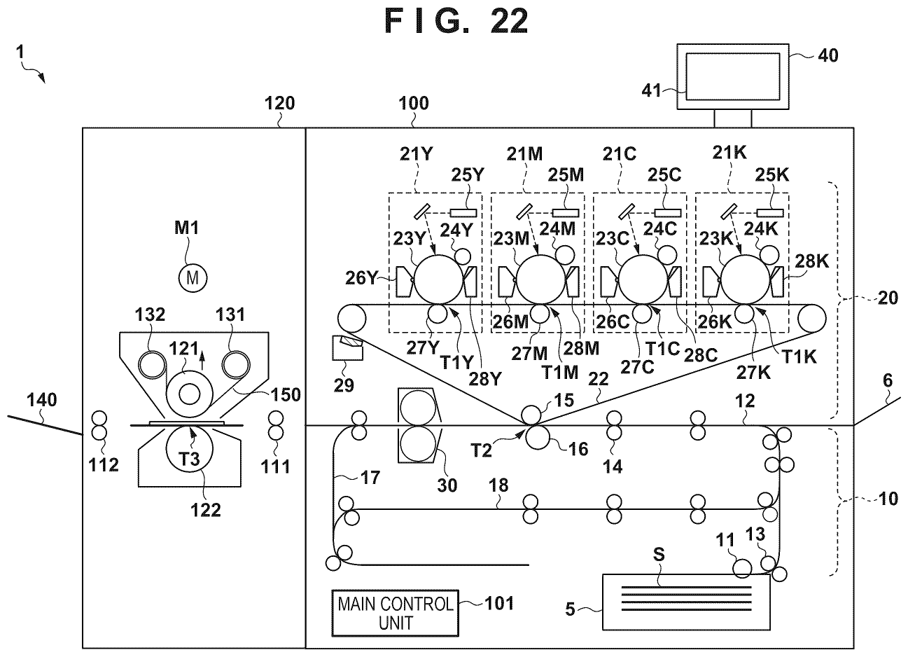

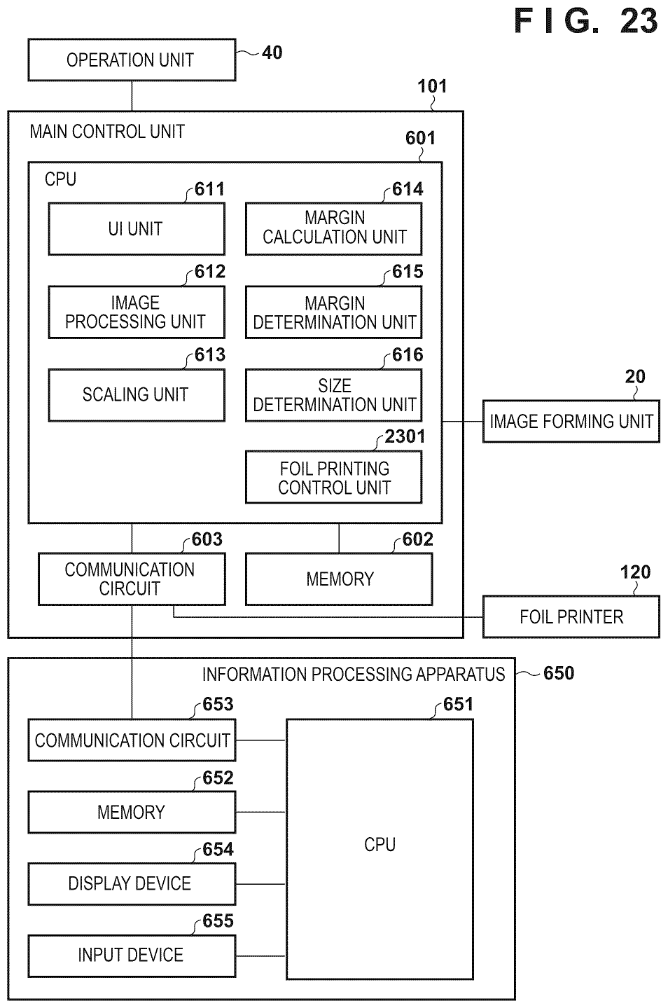

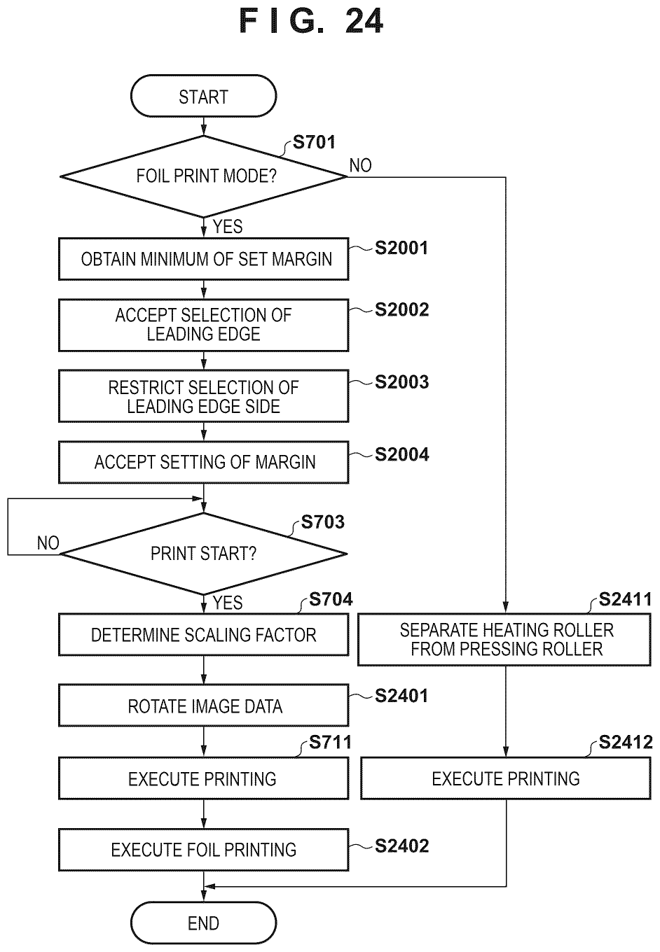

FIG. 21 and FIG. 22 show an image forming system 1 including the foil printer 120 and the image forming apparatus 100 connected to each other. FIG. 21 shows that the heating roller 121 and the pressure roller 122 are in a contact state (in a foil processing state). FIG. 22 shows that the heating roller 121 and the pressure roller 122 are in a separation state (state in which foil processing is not executed). That is, the contact state is adopted in the foil print mode. That is, the separation state is adopted in the normal print mode.

FIG. 23 shows a controller. The foil printing control unit 2301 controls the foil printer 120.

When accepting a print job from the information processing apparatus 650, the image forming apparatus 100 forms a toner image in an area to which foil processing is applied on the sheet S, and the conveyance unit 10 conveys the sheet S to the foil printer 120.

The CPU 601 (foil printing control unit 2301) controls the motor M1 to shift the heating roller 121 and the pressure roller 122 from the separation state to the contact state. The foil printer 120 transfers the foil to the toner image on the sheet S by hot pressing and discharges the sheet S to the discharge tray 140. Accordingly, a foil image is formed on the sheet S. When the foil processing is completed, the CPU 601 (foil printing control unit 2301) controls the motor M1 to shift the heating roller 121 and the pressure roller 122 from the contact state to the separation state. This restricts or prohibits the foil processing to the sheet S that does not require the foil processing.

Incidentally, when the image forming apparatus 100 and the foil printer 120 are connected to each other, the direction of the sheet S discharged from the image forming apparatus 100 corresponds to the direction in which the sheet S is inserted into the foil printer 120. That is, the user cannot change the orientation of the sheet S outputted from the image forming apparatus 100.

Therefore, in the sixth embodiment, when the user inputs a side serving as the leading edge, a toner image is formed on the sheet S such that the input side is the leading edge. Therefore, even when the image forming apparatus 100 and the foil printer 120 are connected to each other, the leading edge margin is sufficiently reserved, and paper jam is less likely to occur in the foil printer 120.

FIG. 24 shows a control method according to the sixth embodiment. Here, differences between FIG. 20 and FIG. 24 will be mainly described.

If the normal print mode is selected, the CPU 601 advances the process from the step S701 to the step S2411. In the step 2411, the CPU 601 (foil printing control unit 2301) controls the motor M1 to separate the heating roller 121 from the pressure roller 122. After that, the CPU 601 controls the image forming unit 20 to execute printing.

When it is determined that the foil print mode is selected in the step S701, the CPU 601 advances the processing from the step S701 to the step S2001, executes the step S2001 to the step S2004, and advances the processing to the step S703.

The CPU 601 executes the step S703 and the step S704 and advances the process to the step S2401. In the step S2401, the CPU 601 (image processing unit 612) rotates the image data so that an image can be formed with the selected edge as a leading edge. The orientation of the sheet S depends on the orientation (e.g. A4/A4R) of the sheet S accommodated in the sheet cassette or the sheet tray. Thus, the edge selectable by the user is the top or bottom side, or the left or right side.

In the step S711, the CPU 601 controls the image forming unit 20 to form a toner image on the sheet S. In the step S2402, the CPU 601 (foil printing control unit 2301) controls the foil printer 120 to perform foil printing on the sheet S conveyed from the image forming apparatus 100.

In this way, even when the image forming apparatus 100 and the foil printer 120 are connected to each other, enough margin is reserved on the edge selected as the leading edge (the step S2001 to the step S2004). Therefore, the paper jam in the foil printer 120 caused by the shortage of the margin is reduced.

Note that, in the above description, it is assumed that the heating roller 121 and the pressure roller 122 are in contact with each other in a default state. However, this is only an example. The heating roller 121 and the pressure roller 122 may be separated from each other in a default state. Here, between the step S701 and the step S2001, the CPU 601 controls the motor M1 to bring the heating roller 121 and the pressure roller 122 into contact with each other. In addition, after the step S2402, the CPU 601 controls the motor M1 to bring the heating roller 121 and the pressure roller 122 into separated with each other. The step S2411 can be omitted.

In the sixth embodiment, when the image forming apparatus 100 and the foil printer 120 are connected to each other, the margin setting is restricted (the fifth embodiment). However, this is only an example. Instead of the fifth embodiment, a warning may be issued when the leading edge margin is smaller than the threshold (the second embodiment and the third embodiment).

### VII. Supplemental Description

The image forming unit 20 is an example of an image forming unit that forms a toner image used in the foil printer 120 on the sheet S as an adhesive for adhering the foil to the sheet. The operation unit 40, the input device 655, and the UI 400 are examples of a selection unit or an input unit that selects a first mode for forming a toner image for adhering foil onto a sheet via a toner image. The operation unit 40, the input device 655, and the margin setting UI 500 function as an accepting unit or an input unit that accepts information related to a margin area that is set to be an area where no toner image is formed by the image forming unit among the sheets. When the first mode is selected, the operation unit 40 and the display device 654 function as a display unit that displays a warning according to the information related to the margin area. This reduces the likelihood of a defect occurring when forming the foil.

The margin area (margin-on-paper Wpaper) existing from the edge of the sheet S to the toner image 801 may be smaller than the threshold Wth associated with the foil printer 120. In this case, the operation unit 40 and the display device 654 may output warning information (e.g. a warning UI 900, a warning message 901, and a warning image 902). This reduces the frequency of jams occurring in the foil printer 120.

The threshold Wth may be the minimum margin defined in an instruction manual of the foil printer 120. The instruction manual may contain minimum margins that the user must reserve.

The operation unit 40, the input device 655, and the margin setting UI 500 can function as an input unit that accepts an input of the size of a margin area. The foil print mode is an example of a first mode for forming a toner image used as an adhesive of foil in the foil printer 120. The normal print mode is an example of a second mode for forming a toner image that is not used as an adhesive of foil in the foil printer 120. The CPU 601, 651 and the margin determination unit 615 function as a determination unit or a controller that determines whether or not the size of the margin area acquired from the information input through the input unit is smaller than a threshold when the first mode is selected. In this way, a mode for foil printing may be provided.

At least one of the four margins in the sheet S may be smaller than a threshold value. In this case, the warning information may be output.

Among the four margins in the sheet S, one margin with respect to the leading edge of the sheet S in the direction in which the sheet S is inserted into the foil printer 120 may be smaller than a threshold value. In this case, the warning information may be output.

The warning information may include a warning image 902 indicating a margin smaller than the threshold value Wth among the four margins in the sheet S.

Among the four margins in the sheet S, there may be a margin greater than the threshold value Wth. The warning information may include insertion direction information indicating that the edge of the sheet S close to the margin should be the leading edge in the direction in which the sheet S is inserted into the foil printer 120.

There is a case where all of the four margins in the sheet S may be smaller than a threshold value. The warning information may include information indicating that a jam may occur when the sheet S is inserted into the foil printer 120.

There is a case where the margin provided at an edge designated as the leading edge in the direction in which the sheet S is inserted into the foil printer 120 among the four edges of the sheet is smaller than the threshold value. The warning information may include a message prompting the user to enlarge a margin provided at the edge designated as the leading edge. The warning information may include a message prompting that another edge, different from the designated edge as the leading edge, should be re-designated.

As illustrated in FIG. 10B, the image forming unit 20 may form text or a mark indicating that the leading edge of the sheet S in the direction in which the sheet S is inserted into the foil printer 120 is to be formed in a margin greater than the threshold value among the four margins in the sheet S. In FIG. 10B, X is adopted as the mark, but other images or text, such as an arrow indicating the insertion direction, may be adopted.

As illustrated in FIG. 12, among the four edges of the sheet S, an input unit (e.g. a checkbox 1201) may be provided that accepts an input designating the leading edge in the direction in which the sheet S is inserted into the foil printer 120. The operation unit 40 or the like may output the warning information when the margin from the leading edge designated through the input unit to the toner image is smaller than the threshold value.

The operation unit 40 or the input device 655 may accept the input of the designation of the leading edge through an input screen including checkboxes 1201 to 1204 respectively provided corresponding to the four edges of the sheet S.

The CPU 601, 651 and the margin setting UI 500 may function as an adjustment unit or a controller for adjusting image data that is the basis of the toner image so that the margin is enlarged when the margin is smaller than the threshold value. This may reduce the occurrence of jams.

The CPU 601, 651 may be configured to adjust the image data based on an instruction to enlarge a margin input by the user. In this way, the margin may be adjusted manually.

The touch panel 41 and the display device 654 may function as a display unit that displays an input screen for accepting an input of an instruction to enlarge a margin. The CPU 601, 651 may be configured to adjust the image data based on an instruction to enlarge a margin input by the user through the input screen.

The CPU 601, 651, the image processing unit 612, and the scaling unit 613 may reduce the toner image so that the margin is greater than the threshold.

As illustrated in FIG. 9, the CPU 601, 651 and the image processing unit 612 may omit the edge portion of the toner image so that the margin is greater than the threshold.

The adjustment unit or the controller may rotate the toner image 90 degrees such that the margin is greater than the threshold.

The CPU 601, 651 may include a manual mode for enlarging a margin based on a margin value operated by a user, and an automatic mode for enlarging a margin without accepting an operation of the margin value by the user. FIG. 16 illustrates an automatic mode.

The CPU 601 and the communication circuit 603 may transmit the warning information to the information processing apparatus 650 capable of communicating with the image forming apparatus 100.

The operation unit 40, the input device 655, and the size setting unit 1700 can function as an input unit that accepts an input of a size of the sheet S. The CPU 601, 651 may function as a determination unit or a controller that determines, based on the size, the edge of the four edges of the sheet S that can be designated as the leading edge of the sheet S in the direction of insertion into the foil printer 120. As illustrated in FIG. 19, the operation unit 40 and the input device 655 may function as an accepting unit or an input unit that accepts designation of the leading edge of the four edges of the sheet S in the direction in which the sheet S is inserted into the foil printer 120. The operation unit 40, the input device 655, and the margin setting UI 500 accept designation as a leading edge of an edge determined to be designatable as a leading edge among the four edges of the sheet S. The operation unit 40, the input device 655, and the margin setting UI 500 does not accept designation as a leading edge of an edge determined not to be designatable as a leading edge.

The margin may be a sum of the first margin and the third margin. The first margin is a margin (e.g. a set margin Wset) set by the user in advance. The third margin is obtained by multiplying the second margin (e.g. Wdata) from the edge portion in the image data serving as the basis of the toner image of the predetermined density by the scaling factor (e.g. Ax, Ay).

As FIG. 21 illustrates, the foil printer 120 may be connected to the image forming apparatus 100. The foil printer 120 may include a pair of rollers (a heating roller 121 and a pressure roller 122) for attaching foil to the sheet S, and a motor (e.g. a motor M1) for bringing the pair of rollers into contact with or away from each other. The motor M1 brings the pair of rollers into contact with each other in a first mode in which the image forming apparatus 100 forms a toner image that is used as an adhesive of foil in the foil printer 120. The motor M1 brings the pair of rollers into separate with each other in a second mode in which the image forming apparatus 100 forms a toner image that is not used as an adhesive of foil in the foil printer 120.

The operation unit 40 and the display device 654 may output warning information before the image forming unit 20 forms a toner image on the sheet S.

The communication circuit 653 is an example of a communication unit that communicates with the image forming apparatus 100 that forms a toner image on the sheet S. The display device 654 may output the warning information when the margin from the edge of the sheet S to the toner image is smaller than the threshold value associated with the foil printer 120 that uses the toner image formed on the sheet S as an adhesive for adhering the foil to the sheet S.

As illustrated in FIG. 20 and the like, the operation unit 40 and the margin setting UI 500 may restrict setting of a margin so that the margin is greater than the threshold value Wth associated with the foil printer 120.

The operation unit 40 and the margin setting UI 500 may accept setting of a margin greater than a threshold value, and may not accept setting of a margin smaller than the threshold value.

The touch panel 41 or the like may function as a display unit that displays direction information indicating the direction in which the sheet S is inserted into the foil printer 120 based on the setting of the margin.

The operation unit 40 and the input device 655 function as an input unit for accepting an input of a designation as the leading edge of the four edges of the sheet S in the direction of insertion of the sheet S into the foil printer 120. The margin may be a margin from an edge designated as the leading edge of the four edges to the toner image.

The operation unit 40 and the input device 655 may not accept the designation as the leading edge of the four edges of the sheet S, which is smaller in margin than the threshold value Wth, and may accept the designation as the leading edge of the sheet S, which is greater in margin than the threshold value Qth.

The CPU 601, 651 may control the image forming apparatus 100 so that the orientation of the toner image with respect to the sheet S is the orientation according to the designation of the leading edge.

The communication circuit 653 communicate with the image forming apparatus 100 that forms a toner image used in the foil printer 120 on the sheet S as an adhesive for adhering the foil to the sheet S. The CPU 651 and the input device 655 accepts the selection of the mode and information related to the margin area. The CPU 651 and input device 655 may restrict the setting of the margin according to the information related to the margin area when the first mode is selected.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-060396, filed Apr. 3, 2024 which is hereby incorporated by reference herein in its entirety.

What is claimed is:

1. An image forming apparatus comprising:
an image forming unit configured to form a toner image on a sheet;
an input unit configured to accept a selection of a first mode for forming the toner image for adhering foil onto the sheet via the toner image, and an input of information related to a margin area set to be an area where the toner image is not formed by the image forming unit on the sheet; and
a display unit configured to display a warning according to the information related to the margin area in a case where the first mode is selected by the input unit.

2. The image forming apparatus according to claim 1, wherein
the display unit is further configured to display the warning in a case where a size of the margin area is smaller than a threshold value associated with a foil printer that adheres the foil to the sheet via the toner image.

3. The image forming apparatus according to claim 2, wherein
the threshold value is a minimum margin defined in an instruction manual of the foil printer.

4. The image forming apparatus according to claim 2, further comprising
a controller configured to determine whether a size of the margin area obtained from information input through the input unit is smaller than the threshold value in a case where the first mode is selected among the first mode and a second mode for forming a toner image that is not used as an adhesive of the foil in the foil printer.

5. The image forming apparatus according to claim 2, wherein
the warning is displayed in a case where a size of at least one of four margin areas in the sheet is smaller than the threshold value.

6. The image forming apparatus according to claim 2, wherein
the warning is output in a case where, among four margin areas in the sheet, a size of one margin area with respect to a leading edge of the sheet in a direction in which the sheet is inserted into the foil printer is smaller than the threshold value.

7. The image forming apparatus according to claim 2, wherein
the warning includes a warning image indicating a margin area having a size smaller than the threshold value among four margin areas in the sheet.

8. The image forming apparatus according to claim 2, wherein
the warning includes inserting direction information indicating that an edge of the sheet, which is close to a margin area having a size greater than the threshold value, among four margin areas in the sheet is to be a leading edge in a direction in which the sheet is inserted into the foil printer.

9. The image forming apparatus according to claim 2, wherein
the warning includes information indicating that a jam may occur in a case where the sheet is inserted into the foil printer in a case where all sizes of four margin areas in the sheet are smaller than the threshold value.

10. The image forming apparatus according to claim 2, wherein
the warning includes a message for prompting a user to enlarge the margin area provided at an edge designated as the leading edge, or a message for prompting the user to re-designate another edge different from the edge designated as the leading edge in a case where a size of the margin area provided at the edge designated as the leading edge in the direction in which the sheet is inserted into the foil printer among four edges of the sheet is smaller than the threshold value.

11. The image forming apparatus according to claim 2, wherein
The image forming unit is further configured to form text or a mark indicating that a leading edge of the sheet in a direction in which the sheet is inserted into the foil printer is to be set in a margin area greater than the threshold value among four margin area in the sheet.

12. The image forming apparatus according to claim 2, wherein
the input unit is further configured to accept an input of designation of a leading edge of four edges of the sheet in a direction in which the sheet is inserted into the foil printer, and
the display unit is further configured to display the warning in a case where a size of a margin area existing from a leading edge designated through the input unit to the toner image is smaller than the threshold value.

13. The image forming apparatus according to claim 12, wherein
the input unit is further configured to accept an input of designation of the leading edge through an input screen including checkboxes respectively provided corresponding to four edges of the sheet.

14. The image forming apparatus according to claim 2, further comprising
a controller configured to adjust image data serving as a basis of the toner image so that the margin area is enlarged, in a case where a size of the margin area is smaller than the threshold value, and
the controller is further configured to adjust the image data based on an enlargement instruction of the margin area input by a user.

15. The image forming apparatus according to claim 14, wherein
the display unit is further configured to display an input screen for accepting an input of an enlargement instruction of the margin area, and
the controller is further configured to adjust the image data based on an enlargement instruction of the margin area input by a user through the input screen.

16. The image forming apparatus according to claim 2, further comprising
a controller configured to adjust image data serving as a basis of the toner image so that the margin area is enlarged, in a case where a size of the margin area is smaller than the threshold value, and
the controller is further configured to reduce the toner image so that a size of the margin area is greater than the threshold value.

17. The image forming apparatus according to claim 2, further comprising
a controller configured to adjust image data serving as a basis of the toner image so that the margin area is enlarged, in a case where a size of the margin area is smaller than the threshold value, and
the controller is further configured to omit an edge portion of the toner image so that a size of the margin area is greater than the threshold value.

18. The image forming apparatus according to claim 2, further comprising
a controller configured to adjust image data serving as a basis of the toner image so that the margin area is enlarged, in a case where a size of the margin area is smaller than the threshold value, and
the controller is further configured to rotate the toner image by 90 degrees so that a size of the margin area is greater than the threshold value.

19. The image forming apparatus according to claim 2, further comprising
a controller configured to adjust image data serving as a basis of the toner image so that the margin area is enlarged, in a case where a size of the margin area is smaller than the threshold value, and
the controller comprises:
a manual mode for enlarging the margin area based on a margin value operated by a user; and
an automatic mode for enlarging the margin area without accepting an operation of the margin value by the user.

20. The image forming apparatus according to claim 1, further comprising
a transmitting unit configured to transmit the warning to an information processing apparatus capable of communicating with the image forming apparatus.

21. The image forming apparatus according to claim 1, further comprising a controller configured to:
based on a size of the sheet input through the input unit, determine, among four edges of the sheet, an edge that can be designated as a leading edge in a direction in which the sheet is inserted into a foil printer; and
accept designation of the leading edge in the direction in which the sheet is inserted into the foil printer among the four edges of the sheet through the input unit, and
wherein the controller is further configured:
to accept a designation for an edge, as the leading edge, determined to be designatable as the leading edge among the four edges of the sheet,
not to accept a designation for an edge, as the leading edge, which is not determined to be designatable as the leading edge among the four edges of the sheet,

22. The image forming apparatus according to claim 2, wherein the margin area is a sum of:
a first margin area set by ae user in advance; and
a third margin area obtained by multiplying a second margin area from an edge portion in the image data serving as the basing of the toner image to an image of a predetermined density by a scaling factor.

23. The image forming apparatus according to claim 1, wherein
a foil printer is connected to the image forming apparatus, and the foil printer includes:
a pair of rollers configured to attach the foil to the sheet;
a motor configured to abut or separate the pair of rollers,
the motor is further configured to:
bring the pair of rollers into contact in the first mode in which the image forming apparatus forms the toner image to be used as an adhesive of the foil in the foil printer; and
bring the pair of rollers into separate in a second mode in which the image forming apparatus forms a toner image to be not used as an adhesive of the foil in the foil printer.

24. An image forming system comprising:
an image forming apparatus; and
a foil printer configured to adhere foil to a sheet via a toner image formed on the sheet by the image forming apparatus,
wherein the image forming apparatus comprising:
an image forming unit configured to form a toner image on a sheet;
an input unit configured to accept a selection of a first mode for forming the toner image for adhering foil onto the sheet via the toner image, and an input of information related to a margin area set to be an area where the toner image is not formed by the image forming apparatus on the sheet; and
a display unit configured to display a warning according to the information related to the margin area in a case where the first mode is selected by the input unit.

25. The image forming system according to claim 24, wherein
the display unit is further configured to display the warning before the image forming unit forms the toner image on the sheet.

26. An information processing apparatus comprising:
a communication unit capable of communicating with a image forming apparatus for forming a toner image on a sheet;
an input unit configured to accept a selection of a first mode for forming the toner image for adhering foil onto the sheet via the toner image, and an input of information related to a margin area set to be an area where the toner image is not formed by the image forming unit on the sheet; and
a display unit configured to display a warning according to the information related to the margin area in a case where the first mode is selected by the input unit.
